(19) United States
(12) Patent Application Publication
(10) Pub. No.: US 2008/0112269 A1
(43) Pub. Date: May 15, 2008

(54) Time Broadcast Receiving Time Clock

(76) Inventor: Frank Edward Lawton, San Clemente, CA (US)

Correspondence Address: QUICKPATENTS, INC., 32861 CALLE PERFECTO, SUITE A, SAN JUAN CAPISTRANO, CA, 92675, US

(21) Appl. No.: 11/559,619

(22) Filed: Nov. 14, 2006

(51) Int. Cl. G04C 13/08; G04G 5/00

(52) U.S. Cl. 368/10; 368/47

(57) ABSTRACT

An electronic time switch for switching a power source to a load, such as a lighting circuit, is disclosed, as well as a method for its use. An electric switch has an on and an off position for either connecting or disconnecting the power source to the load. A switch actuating means controlled by a microcontroller is connected to the electric switch and is adapted for actuating the switch into either its on or off positions according to a schedule. The microcontroller includes a clock means, a time update means, and a memory means for storing the schedule. The time update means includes a receiver for receiving a time signal from a time signal source, such as a WWVB radio broadcast, or from an earth orbiting satellite, such as a GPS satellite or the like. Preferably the clock means further tracks the date, the memory means further includes a location designator, and the microcontroller includes an event time calculator for determining the sunset time and the sunrise time for the date at the location specified by the location designator. The sunrise and sunset times, offset by an offset time, may signify when the microcontroller causes the switch to disconnect or connect the power source to the load.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to electronic time switches, and more particularly to an electronic time switch that receives updating time signals.

### DISCUSSION OF RELATED ART

Time switches are known in the art for controlling electric items such as outdoor lighting circuits, pool pumps and equipment, irrigation systems, and the like. A common style of time switch is disclosed, for example, in U.S. Pat. No. 3,555,214 to Lee on Jan. 12, 1971. U.S. Pat. No. 3,673,413 to Lee on Aug. 28, 1970 is another example of such a device. These types of time switches are widely used and typically are typically installed by electricians who, once having installed such a device, mechanically set the time, ensure that the device is working, and then leave the owner of the property to maintain the time settings.

With some installations it is not always necessary for the time to be set accurately. For example, if a pool pump is set to be active for two hours each day, it typically matters little which two hours the pool pump is on, although the property owner may have a preference for a particular time of day. However, with other types of equipment, or in certain situations, it may be extremely important that the time setting on such a time switch be accurately set. For example, with outdoor safety lighting if the time switch is off by an hour or more the area to be lit may be in complete darkness by the time the lights are switched on. Likewise, once the sun has risen there is no need to keep lights on, wasting energy.

The time keeping component of prior art devices, whether mechanical or electrical, will become inaccurate over time as the set time drifts from the actual time. As such, with these devices it is necessary to manually maintain the time periodically to ensure that the time switch is accurately set. Further, daylight savings time events, where the actual time jumps by one hour from one day to the next, require similar maintenance. Maintaining such time switches, particularly where there are many such installations, is a time consuming and expensive process. Not properly maintaining the time on such device, however, can be even more expensive in terms of energy waste or safety issue.

Clocks that update automatically based on WWVB, WWV, WWVH and similar broadcasts are also known in the art. For example, U.S. Pat. No. 4,234,958 to Pipes et al. on Nov. 18, 1980; U.S. Pat. No. 4,569,598 to Jacobs on Feb. 11, 1986; U.S. Pat. No. 4,582,434 to Plangger et al. on Apr. 15, 1986; U.S. Pat. No. 5,363,348 to Damle on Nov. 8, 1994; U.S. Pat. No. 6,223,050 to Roberts, Jr., on Apr. 24, 2001; and U.S. Pat. No. 6,343,050 to Kwok on Jan. 29, 2002; hereby incorporated herein by reference, all teach such devices. None of these devices, however, are adapted to control a time switch in a hard-wired installation for switching a power source to a load, such as a lighting circuit. Further, none of these prior art automatically-setting clocks suggest means for automatically calculating sunrise and sunset times based on the date and the location of the device for the purposes of setting an activation and deactivation schedule.

In US Patent Application 2004/0207522 to McGee et al., a method of generating an alarm based on time and geographic data is disclosed, but such a method does not involve a time switch nor does such a method suggest its use with a time switch. Such a method is directed towards use with a portable electronics device, not a hard-wired permanently installed device suitable for operating an outdoor parking lot lighting circuit, for example.

Therefore, there is a need for a time switch that regularly updates its internal clock based on time signal broadcasts of accurate time signals. Such a needed device would be able to calculate both sunrise and sunset times for the date and location in which the device is installed. Further, such a needed invention would account for Daylight Savings Time fluctuations, and would further provide flexibility in terms of offsetting the timing the activation or deactivation of the switch as desired with respect to the sunrise and sunset times. The needed device would be able to receive a variety of time signals based on what is available at its location, and would allow a location designator to be assigned in several convenient ways, including deriving location from a plurality of GPS satellites. The present invention accomplishes these objectives.

### SUMMARY OF THE INVENTION

The present device is an electronic time switch for switching a power source to a load, such as a lighting circuit. An electric switch of the time switch has an on position and an off position for either connecting or disconnecting the power source to the load. A switch actuating means controlled by a microcontroller is connected to the electric switch and adapted for actuating the switch into either its on or off positions according to a schedule. The microcontroller includes a clock means, such as an electronic clock circuit for tracking the current time, a time update means, and a memory means, such as RAM, for storing the schedule. A DC power source powers the microcontroller and switch actuating means.

The time update means includes a receiver for receiving a time signal from a time signal source, such as a WWVB radio broadcast, or from an earth orbiting satellite, such as a GPS satellite or the like. A second schedule may be included in the memory means for designating a regular time for the microcontroller to activate the time update means.

Preferably the clock means further tracks the date, and the memory means further includes a location designator and the microcontroller includes an event time calculator for determining the sunset time and the sunrise time for the date at the location specified by the location designator. In one embodiment of the invention, the sunset time signifies the time when the microcontroller causes the switch to connect the power source to the load, and the sunrise time signifies the time when the microcontroller causes the switch to disconnect the power source from the load. In another embodiment, an offset time may be included, the microcontroller advancing the switching on of the power source to the load by the offset time, and delaying the switching off of the power source from the load.

The present invention is a time switch that regularly updates its internal clock based on time signal broadcasts of accurate time signals. Such a needed device would be able to calculate both sunrise and sunset times for the date and location in which the device is installed. Further, such a needed invention would account for Daylight Savings Time fluctuations, and would further provide flexibility in terms of offsetting the timing the activation or deactivation of the switch as desired with respect to the sunrise and sunset times. The needed device would be able to receive a variety of time signals based on what is available at its location, and would allow a location designator to be assigned in several convenient ways, including deriving location from a plurality of GPS satellites. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is front elevational view of the invention, illustrating an electric time switch of the invention receiving a time signal from either a land-based transmitter or a satellite;

FIG. 2 is a timeline showing the state of an electric switch of the invention during an arbitrary 24-hour day;

FIG. 3 is a table showing a schedule of the invention, indicating sunrise and sunset times for a specific date and location, and optionally providing an offset time;

FIG. 4 is a flow diagram of an activation mode of the present invention; and

FIG. 5 is a logical block diagram of the electronic time switch of the present invention.

### DETAILED DESCRIPTION OF THE PREFERRED EMBODIMENT

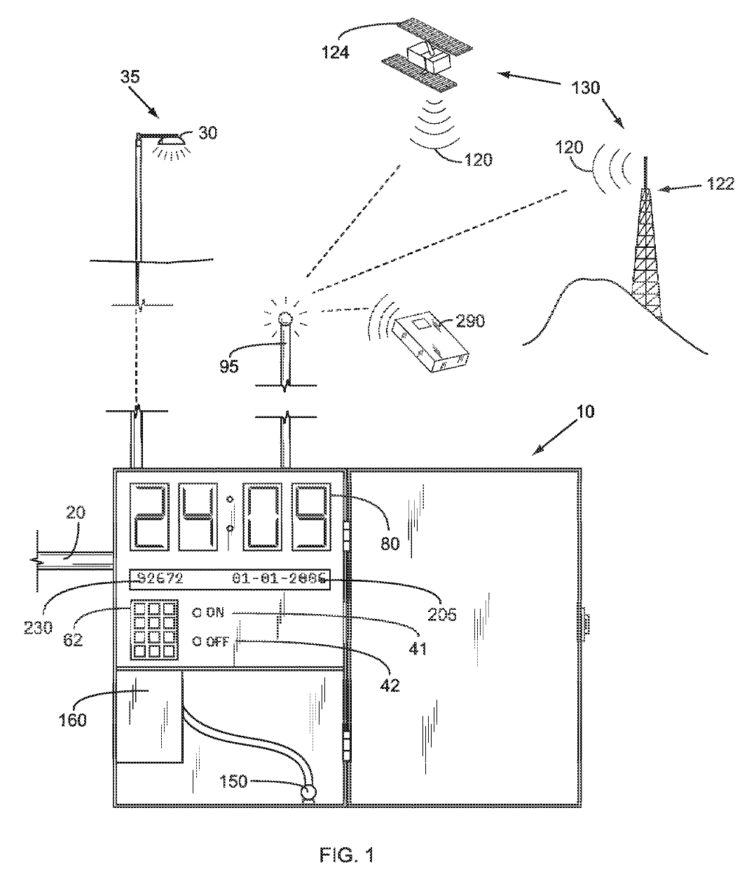

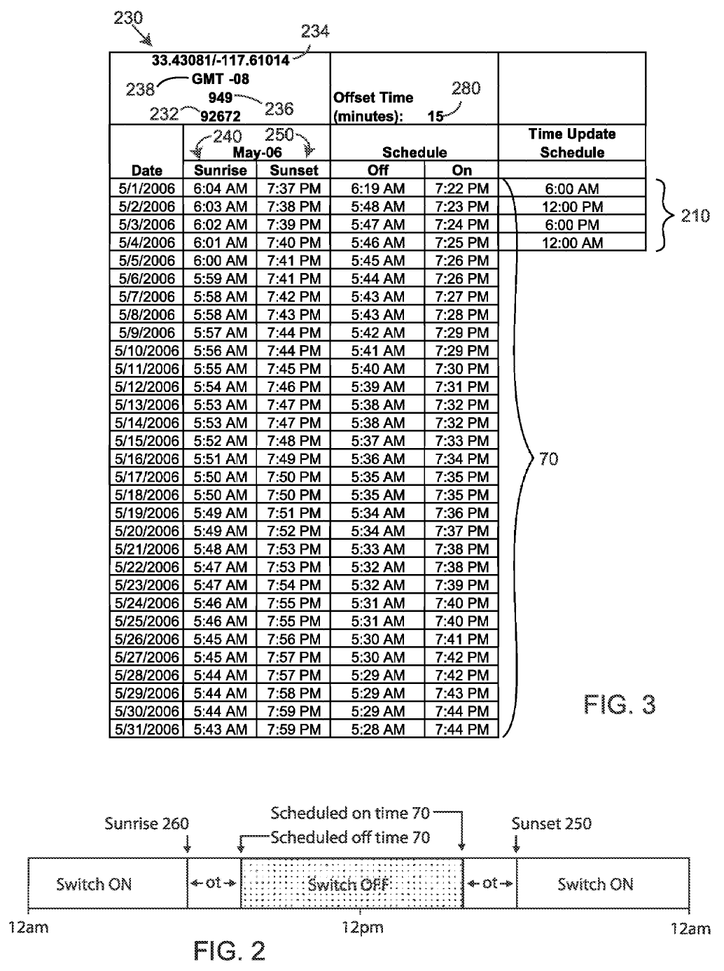

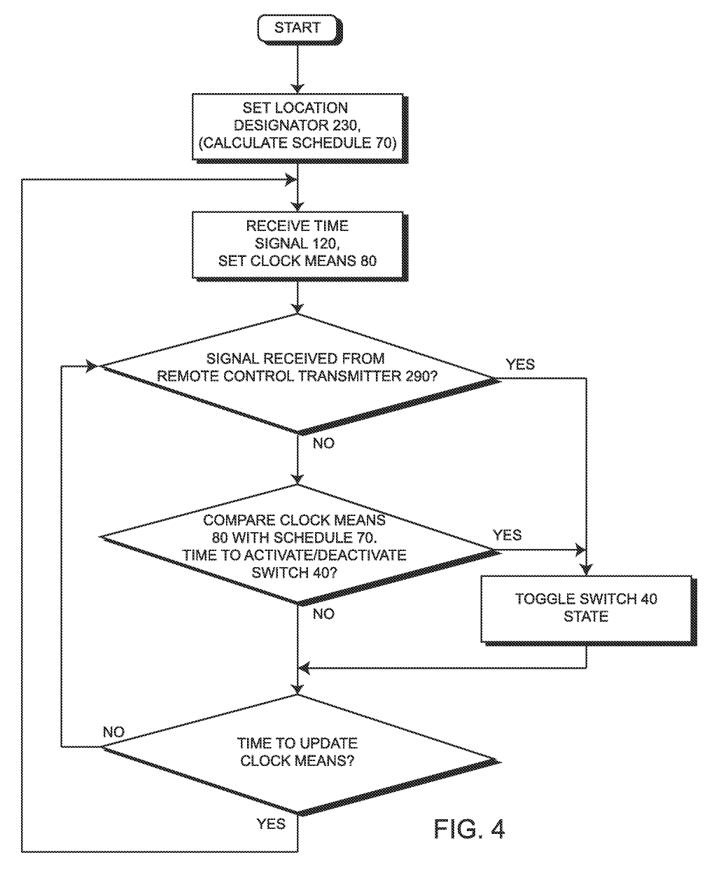

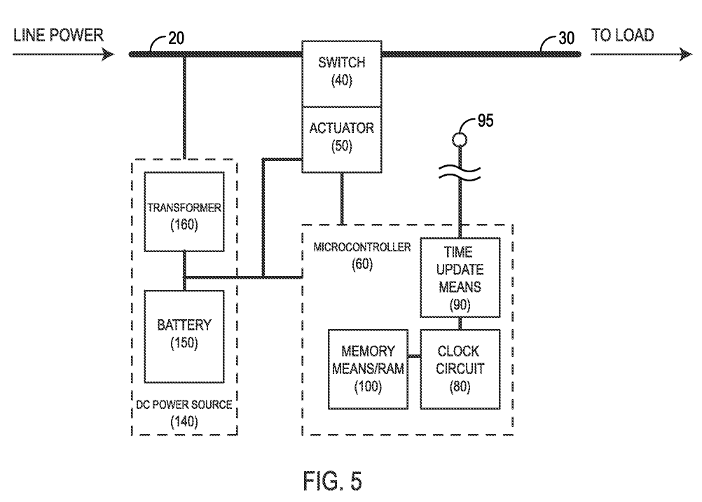

FIG. 1 illustrates an electronic time switch 10 for switching a power source 20 to a load 30, such as a lighting circuit 35. The power source may be an AC line source, such as a 120 V, 240 V, or 480 V power source. An electric switch 40 (FIGS. 1 and 5) of the time switch 10 has an on position 41 and an off position 42. The on position 41 connects the power source 20 to the load 30, and the off position 42 disconnects the power sources 20 from the load 30. A switch actuating means 50 is connected to the electric switch 40 and adapted for actuating the switch 50 into either its on or off positions 41,42. The switch actuating means 50 may be a solenoid mechanically connected to the switch 40, a relay wherein the switch 40 is included within the relay, or a solid-state transistor device electrically connected to a solid-state switch (not shown), as is known in the art. A manual actuation means (not shown) may also be included for manually setting the switch 40 into either its on or off positions 41,42.

A microcontroller 60 interconnected with the switch actuating means 50 therethrough controls the switch 40 in accordance to a schedule 70 (FIG. 5). The microcontroller 60 includes a clock means 80, a time update means 90, and a memory means 100 for storing the schedule 70. Such a microcontroller 60 may be a microprocessor, or the like. The clock means 80 is a clock circuit for tracking the current time and communicating same to the microcontroller 60, as is known in the art, and the memory means 100 is preferably RAM type electronic memory, but can also be EEPROM or other read/write memory accessible by the microcontroller 60. The microcontroller 60 is mounted with the clock means 80, at least a portion of the time update means 90, and memory means 100 on a PC board (not shown), as is common in the art.

A DC power source 140 powers the microcontroller 60 and switch actuating means 50 (FIG. 5). The DC power source 140 may be a battery 150, a transformer 160 for converting a portion of the power source 20, in the event that the power source 20 is an AC power source 20, into the DC power source 140, or a combination of the transformer 160 and the battery 150. In the later instance, the transformer 160 may be used at least partially to charge the battery 150, the battery 150 being of the rechargeable type.

The time update means 90 includes a receiver 110 for receiving a time signal 120 from a time signal source 130. The time signal 120 may be from a WWVB radio broadcast 122 transmitting out of Fort Collins, Colo., for example, or a signal 122 broadcast from an earth orbiting satellite 124, such as a GPS satellite or the like (FIG. 1). The time update means 90 includes a suitable antenna means 95 for receiving such a time signal 120, as is known in the art. With installations inside electrical rooms, the antenna means 95 may be a cable that extends to a suitable location for adequate reception of the time signal 120. Based upon the type of time signal 120 received, the microcontroller can also calculate whether Daylight Savings Time applies and update the clock means 80 accordingly.

A second schedule 210 may be included in the memory means 100 for designating a regular time for the microcontroller 60 to activate the time update means 90 (FIG. 3), ranging from several times per day to once a month, depending upon the selected accuracy of the clock means 80. Preferably the clock means 80 further tracks the date 205, and the memory means 100 further includes a location designator 230 and the microcontroller 60 includes an event time calculator 240 for determining the sunset time 250 and the sunrise time 260 for the date 205 at the location specified by the location designator 230. The sunset time 250 signifies the time when the microcontroller 60 causes the switch 40 to connect the power source 20 to the load 30, and the sunrise time 260 signifies the time when the microcontroller 60 causes the switch 40 to disconnect the power source 20 from the load 30. An offset time 270 may be included, the microcontroller 60 advancing the switching of the power source 20 to the load 30 by the offset time 270, and delaying the switching off of the power source 20 from the load 30. The location designator 230 may be entered into the memory means 80 by use of a suitable input device 62 interconnected to the microcontroller 60 (FIG. 1), such as a plurality of buttons, a numerical keypad, or other suitable means known in the art.

Preferably the location designator 230 is at least a portion of a postal code 232, a longitude and latitude coordinate 234, a telephone area code 236, or a time zone designator 238. The longitude and latitude coordinates 234 are preferred in the case where the time signal 120 is received from a GPS or similar satellite 124 and the time update means 90 further includes a location updating circuit for calculating the location designator 230 based on the signals 120 received from a plurality of GPS satellites 124.

A remote signal receiving means 280 may be adapted for signaling the microcontroller 60 to toggle the position of the switch 40 upon receiving a signal from the remote control transmitter 290. As such, a maintenance worker checking the status of light bulbs on the lighting circuit 35, for example, may remotely turn the circuit 35 on to check the bulbs, temporarily overriding the schedule 70.

In use, upon installation and applying suitable power 20 to the electric time switch 10, the location designator 230 is set in the device either with a GPS location signal or by manually entering a suitable designator 230 into the input means 62. The time switch 10 is then placed in an activation mode, wherein the microcontroller 60 attempts to receive the time signal 120 from the time signal source 130 to set the clock means 80. Once the clock means 80 is set with the accurate time, the preset schedule 70 is followed to activate or deactivate the switch actuation means 50 at the proper time. Additionally, the preset schedule 70 may be modified as necessary at any time by a user, either by adjusting the offset time 270 or adjusting the on and off times in the schedule 70 in a schedule modification mode, as is possible with many digital prior art time switches.

In the embodiment that calculates sunrise and sunset times, a further step is included of setting the microcontroller 60 to calculate the schedule 70 based on the location designator 230, the date 205, the calculated sunset 250 and sunrise 260 times. The microcontroller 70 then actuates the switch 40 in accordance to the schedule 70 while regularly receiving the time signal 120 from the time signal source 130 to maintain the accuracy of the clock means 80.

While a particular form of the invention has been illustrated and described, it will be apparent that various modifications can be made without departing from the spirit and scope of the invention. For example, the exact type of time signal 120 received by the electronic time switch 10 may vary based on location and what type of time signals 120 are available at that location. Further, additional on/off times may be introduced into the schedule 70 to effect energy savings, for example, during low-use times of the early morning. Still further, the size and shape of the time switch 10 may vary based on the type of enclosure into which it is to be installed, or it may include its own durable enclosure (not shown). Accordingly, it is not intended that the invention be limited, except as by the appended claims.

What is claimed is:

1. An electronic time switch for switching a power source to a load, comprising:
an electric switch having an on and an off position;
a switch actuating means interconnected with the electric switch and adapted for actuating the switch into either its on or off position;
a microcontroller for activating the switch actuating means in accordance to a schedule, the microcontroller having a clock means, a time update means, a memory means for storing the schedule, the microcontroller interconnected with the switch actuating means and adapted for causing same to set the electric switch in either the on or off position, the time update means including a receiver for receiving a time signal from a time signal source; and
a DC power source for powering the microcontroller and switch actuating means.

2. The electronic time switch of claim 1 wherein the DC power source is a battery.

3. The electronic time switch of claim 1 wherein the power source is an AC power source, and the DC power source is a transformer for converting a portion of the AC power source into the DC power source.

4. The electronic time switch of claim 3 wherein the DC power source is a transformer and a battery in parallel, the transformer for converting some of the power source to charge the battery.

5. The electronic time switch of claim 1 wherein the time signal source is a WWVB radio broadcast.

6. The electronic time switch of claim 1 wherein the time signal source is at least one earth orbiting satellite.

7. The electronic time switch of claim 1 wherein the time signal source is at least one earth orbiting GPS satellite.

8. The electronic time switch of claim 1 wherein the switch actuating means is a solenoid mechanically connected to the switch.

9. The electronic time switch of claim 1 wherein the switch actuating means is a relay mechanically connected to the switch.

10. The electronic time switch of claim 1 wherein the switch actuating means is a solid-state transistor device electrically connected to the switch, and the switch is a solid-state switch.

11. The electronic time switch of claim 1 wherein the microcontroller activates the time update means on a second schedule to update the clock means.

12. The electronic time switch of claim 1 wherein the clock means further tracks the date, and the memory means further includes a location designator and an event time calculator for determining the sunset time and sunrise times for the date at the location specified by the location designator, the sunset time signifying the time when the microcontroller causes the switch to connect the power source to the load, and the sunrise time signifying the time when the microcontroller causes the switch to disconnect the power source from the load.

13. The electronic time switch of claim 12 wherein the location designator is at least a portion of a postal code.

14. The electronic time switch of claim 12 wherein the location designator is a longitude and a latitude coordinate.

15. The electronic time switch of claim 12 wherein the location designator is a telephone area code.

16. The electronic time switch of claim 12 wherein the location designator is a time zone designator.

17. The electronic time switch of claim 12 wherein the memory further stores an offset time, the microcontroller advancing the switching on of the power source to the load by the offset time and delaying the switching off of the power source from the load by the offset time.

18. The electronic time switch of claim 1 further including a remote signal receiving means adapted for causing the microcontroller to toggle the switch upon receiving an “on” or “off” signal from a remote control transmitter.

19. An automatic time switch method comprising the steps of:
a) providing an electronic time switch comprising an electric switch having an on and an off position; a switch actuating means interconnected with the electric switch and adapted for actuating the switch into either its on or off position; a microcontroller for activating the switch actuating means in accordance to a schedule, the microcontroller having a clock means, a time update means, a memory means for storing the schedule, the microcontroller interconnected with the switch actuating means and adapted for causing same to set the electric switch in either the on or off position, the time update means including a receiver for receiving a time signal from a time signal source; and a DC power source for powering the microcontroller and switch actuating means;
b) activating the microcontroller to receive the time signal from the time signal source to set the clock means; and
c) setting the microcontroller to actuate the switch in accordance to the schedule while regularly receiving the time signal from the time signal source to maintain the accuracy of the clock means.

20. An automatic time switch method comprising the steps of:
a) providing an electronic time switch comprising an electric switch having an on and an off position; a switch actuating means interconnected with the electric switch and adapted for actuating the switch into either its on or off position; a microcontroller for activating the switch actuating means in accordance to a schedule, the microcontroller having a clock means, a time update means, a memory means for storing the schedule, the microcontroller interconnected with the switch actuating means and adapted for causing same to set the electric switch in either the on or off position, the time update means including a receiver for receiving a time signal from a time signal source; and a DC power source for powering the microcontroller and switch actuating means; the clock means further tracking the date, and the memory means further including a location designator and an event time calculator for determining the sunset time and sunrise times for the date at the location specified by the location designator, the sunset time signifying the time when the microcontroller causes the switch to connect the power source to the load, and the sunrise time signifying the time when the microcontroller causes the switch to disconnect the power source from the load
b) setting the location designator to designate a physical location on the earth;
c) activating the microcontroller to receive the time signal from the time signal source to set the clock means; and
d) setting the microcontroller to calculate the schedule based on the location designator, the date, the calculated sunset and sunrise times, the microcontroller actuating the switch in accordance to the schedule while regularly receiving the time signal from the time signal source to maintain the accuracy of the clock means.
